(19) United States
(12) Patent Application Publication
(10) Pub. No.: US 2008/0176768 A1
(43) Pub. Date: Jul. 24, 2008

(54) HYDROGEL MICROARRAY WITH EMBEDDED METAL NANOPARTICLES

(75) Inventors: Yuan Zheng, Shanghai (CN); Jicang Zhou, Shanghai (CN); Leon Xu, Shanghai (CN)

Correspondence Address: HONEYWELL INTERNATIONAL INC., 101 COLUMBIA ROAD, P O BOX 2245, MORRISTOWN, NJ, 07962-2245, US

(73) Assignee: Honeywell Honeywell International

(21) Appl. No.: 11/626,104

(22) Filed: Jan. 23, 2007

(51) Int. Cl. C40B 50/18; C40B 40/16

(52) U.S. Cl. 506/21; 506/32

(57) ABSTRACT

A method of creating a metal nanoparticle hydrogel biological array comprises placing a plurality of metal nanoparticles in each of a plurality of wells on a substrate, and placing a biomolecular probe material into the plurality of wells. Hydrogel precursors are placed in each of the plurality of wells; and are polymerized to form hydrogel such that the metal nanoparticles are embedded in the hydrogel.

### FIELD OF THE INVENTION

The invention relates generally to microarrays, and more specifically to a hydrogel microarray assembly with embedded metallic nanoparticles for enhanced fluorescence.

### BACKGROUND

Biomedical instrumentation is often used to determine the presence or amount of a certain biological substance in a solution or sample, such as DNA, proteins, enzymes, and other organic compounds. The tests are conducted for diagnostic purposes, for research, and to control the rate or content of certain reactions. One such biomedical instrumentation system used to detect biological substances is a microarray, typically comprising an array of many different test points or probes. Each probe in the microarray has different biological properties, such as an affinity for a different biological substance, enabling each probe to bind to different biological substances and indicate the presence or approximate amount of a variety of biological substances.

In one example of a microarray biological instrumentation system, the microarray is exposed to a biological material, such as a solution or one or more cells of a certain type, after the biological material is labeled with fluorescent tags. The various biological materials present in the sample bind to various points on the microarray depending on the presence or absence of certain components, such that the fluorescence or lack of fluorescence of a particular probe indicates the presence or absence of the particular component.

In a more detailed example, a microarray of DNA samples containing different genes enables researchers to study hundreds or thousands of genes at the same time, enabling much more rapid research into how cells being tested function and what happens when certain genes in a cell don't function properly. Various gene fragments or sequences are contained in each of the microarray dots or probes, in miniscule amounts. When the genetic messenger molecules that signal the production of proteins from a particular cell are labeled with fluorescent tags and allowed to hybridize or bind to the expressed gene sequence fragments in the microarray, they bind to only those sequences that are complementary to those of the messenger molecules. A scanner measures the fluorescence of each sample on the microarray slide, enabling scientists to determine how active the genes represented by each particular expressed gene fragment are in the cell being tested. Strong fluorescence suggests that many of the cell's messenger molecules hybridized to the expressed gene sequence, and that the particular gene present in the microarray dot is active in the cell. Conversely, lack of fluorescence indicates that the particular gene complementary to the expressed gene sequence is inactive in the cell.

Such research enables a better understanding of how genes work in various types of cells, and their involvement in certain illnesses. For example, cancers can be better understood by their effects on the genetic activity within cancerous cells, and in the differences between normal and cancerous cells of a particular type. Treatment strategies can target these differences, enabling treatments targeted to specific types of cancer. Similarly, observing differences in cancerous cells after undergoing a variety of treatments can suggest which treatments will be most effective at targeting a particular type of cancer.

But, a variety of challenges to efficient biological array analysis remain. Placement or formation of the probes or test points, efficient and specific binding of the probes to the biological sample material, and sensitivity or fluorescence of the probes are all factors in the useful operation of a biological array.

### SUMMARY

One example embodiment of the invention comprises a metal nanoparticle hydrogel biological array including a substrate and a plurality of hydrogel dots arranged in an array on the substrate, each of the plurality of hydrogel dots comprising biomolecular probe material and a plurality of metal nanoparticles. In further embodiments, the metal nanoparticles include at least one of silver or gold, and the hydrogel has a three-dimensional porous structure, allowing more surface accessible to sample biological material under test.

### BRIEF DESCRIPTION OF THE FIGURES

FIG. 1 shows a biological array, consistent with the prior art.

FIG. 2 shows a metal layer enhanced biological array, consistent with the prior art.

FIG. 3 shows a hydrogel biological array including metal nanoparticle enhanced fluorescence, consistent with some example embodiments of the invention.

FIG. 4 is a flow diagram, illustrating one example method of practicing the invention.

FIG. 5 is a pictorial diagram of an example method of practicing the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention provides an improved biological array, comprising a substrate and a plurality of hydrogel dots arranged in an array on the substrate, where each of the plurality of hydrogel dots comprises biomolecular probe material and a plurality of metal nanoparticles. In further embodiments, the metal nanoparticles include at least one of silver or gold, and the hydrogel has a three-dimensional porous structure, allowing more surface accessible to the sample biological materials under test.

FIG. 1 shows a basic microdot biological array, consistent with the prior art. A substrate material 101 such as quartz glass is used to hold an array of microdots 102. The microdots typically comprise a composition including a biological material that is able to bind to a complementary or matched biological material, such as a protein, a DNA segment, or other such biological material. In use, the microdots are exposed to a sample biological material under test, where the test biological material is tagged or marked with a fluorescent material. If a part of the tagged sample matches or is complementary to the biological material contained in the microdot, the sample portion hybridizes or binds to the biological material in the microdot and the microdot becomes fluorescent due to the fluorescent marker attached to the biological sample. The array is therefore scanned after exposure to the sample biological material, under a light known to cause the fluorescent material bound to the biological material under test to fluoresce. The fluorescence of a particular dot therefore indicates presence of a biological material in the sample corresponding to the probe biological material in the dot.

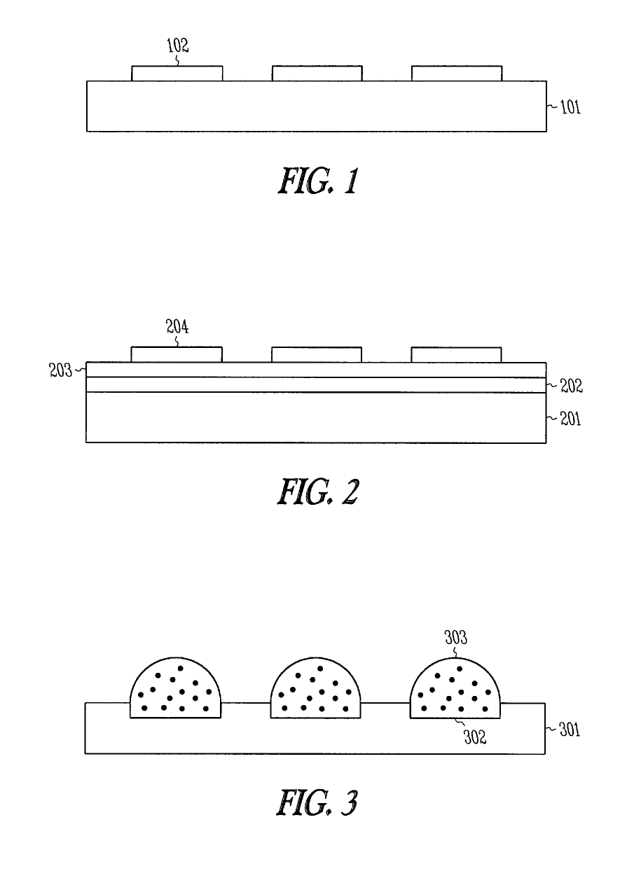

FIG. 2 illustrates an example prior art biological array including a metal layer to provide metal enhanced fluorescence. A substrate material 201, such as quartz glass or another suitable substrate material, has a layer of silver nanoparticle film 202 on one surface. The silver nanoparticle film is coated with a dielectric binding nano film 203, which is used to immobilize or retain an array of biological probe dots 204 arranged on the array assembly. The surface of the probe dots 204 is substantially flat or planar, formed as the dot material is placed as a drop that flattens out on the substrate and binding material.

The silver nanoparticle layer in this example provides what is known as metal enhanced fluorescence, in which the fluorescence near the metal surface is significantly enhanced. Research suggests that the dramatic increase in the fluorescence of materials very near the metal surface, such as within five to twenty nanometers in one example, is due to the interaction of the dipole moment of the fluorescent molecule (label) and the surface plasmon field of the metal resulting in an increase in the radiative decay rate and stronger fluorescence emission. The increase in radiative decay rate results in higher fluorescent quantum yield and shorter life time, which results in brighter and more easily detectable fluorescence.

But, problems remain with even the enhanced biological array of FIG. 2. Immobilization of the probe material, or the biological material present in the dot, is still a challenge. Good binding between the probe material and the biological material under test is also a challenge, as is non-specific binding of the dot to biological materials not matching the probe biological material in the dot.

One embodiment of the invention seeks to solve these and other problems by using metal nanoparticles bound to the biological probe material in each microdot of a hydrogel biological microarray, where the microdot material is a hydrogel having a porous three-dimensional surface, as shown in FIG. 3. The substrate 301 has an array of wells 302, into which metal nanoparticles bound to fluorescent tagged biological probe material are deposited. The metal nanoparticles are suspended in a hydrogel as shown at 303, such that the hydrogel surface is curved or three-dimensional. Under laser illumination, the embedded nanoparticles within the microdot will create an overlapped Plasmon resonance field, resulting in enhanced fluorescence of the label material in the region of the metal nanoparticles. The biological probe materials such as DNA are bound either to the metal nanoparticle surface or to hydrogel backbones in various embodiments.

The metal nanoparticle hydrogel biological microarray has advantages other than enhanced fluorescence, including improved surface area and strong selectivity. The metal nanoparticle hydrogel microarray configuration gives the hydrogel dot 303 a three-dimensional porous structure, and therefore a greater surface area than a flat dot such as is show at 102 of FIG. 1 or 204 of FIG. 2 of the same diameter would have, resulting in greater opportunity for a biological material under test to bind to the probe material embedded in the hydrogel. This is due in part to the reduced steric hindrance, or reduced repulsion among atoms or molecules that are physically near one another. Because there is a greater surface area on a dot that is not substantially planar, such as is shown at 303, there is a greater area over which biological material under test can hybridize or bind to the probe material in the dot. In an alternate embodiment, the surface area of the dots is not increased relative to prior art arrays, but the spot diameter is reduced, enabling a greater number of dots to be placed in a given area.

The hydrogel precursor material can also be designed and selected to possess excellent biological resistance, which can greatly reduce non-specific binding of biological materials during testing. This enhances the selectivity and sensitivity of the microarray-based measurement. Further, the hydrogel material is in some embodiments selected for reduced fluorescence, further enhancing the contrast between dots that have bonded to biological test material and those dots that have not bonded to the fluorescent tagged biological material under test. The biological material used as the probe in the dot is in an alternate embodiment bound to the hydrogel rather than to the metal nanoparticles, such as by being bound to the backbone structure of hydrogel precursor polymers. The metal nanoparticles in various embodiments comprise metals such as gold, silver, other noble metals, or other metallic particles.

Various embodiments utilize at least one of two different approaches to immobilize the biological materials to the microdot. In one approach, the biological probe materials can be immobilized to the metal nanoparticle surface. In another approach, the biological probe material is bound to the hydrogel, such as by being bound to the backbone structure of hydrogel precursor polymers.

The metal nanoparticles in various embodiments comprise metals such as gold, silver, other noble metals, or other metallic particles. There are many approaches available to fabricate of metal nanoparticles with different size and shapes so as to achieve desired performance of the microarray system. In one example, the metal nanoparticles can be fabricated via template synthesis in inverse microemulsions. In another example, the metal nanoparticles can be fabricated via template synthesis in surfactant solutions. One skilled in the art will understand that other approaches available to fabricate the desired metal nanoparticles. The metal nanoparticles are in some embodiments between approximately five and 50 nanometers in diameter, while in other examples are between one and five hundred nanometers in diameter. Moreover, the metal nanoparticles may have different shapes, and in various examplex they include nanospheres, nanorods or nanowires, nanoparticles triads, and so on. Metal nanoparticles with different size and shapes may create plasmon resonance field with different strength in the hydrogel microdots and, therefore, meet the needs of fluorescence enhancement for different applications.

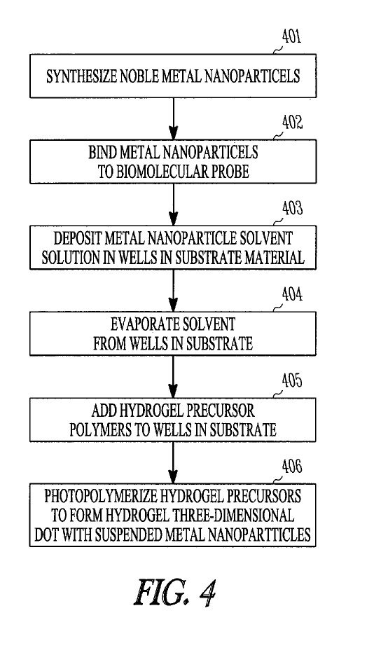

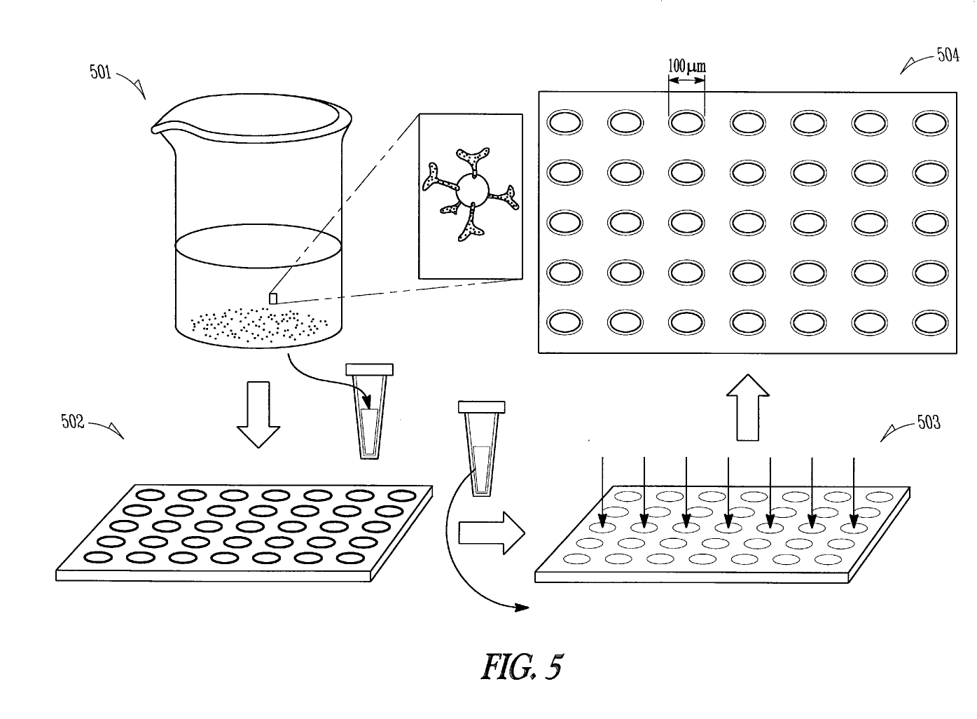

As an illustrative example, a more detailed description of production of a metal nanoparticle hydrogel biological array is shown in FIG. 4. At 401, metal nanoparticles are created such as via any of the approaches mentioned above. The metal nanoparticles are then functionalized before being incorporated into the hydrogel microdots. One or two types of functionalities may be bound to the metal nanoparticles surface in the functionalization process. In one example, two types of functionalities will be bound to the metal nanoparticles surface. Specifically, the metal nanoparticles are bound to polymerizable moieties and biomolecular probe material at 402, such as a DNA sequence, a protein or enzyme, or another biological material. Here, the polymerizable moieties will be copolymerized with the hydrogel precursor material to ensure that the metal nanoparticles are effectively incorporated and stabilized into the hydrogel microdots. In another example, only one type of functionalities will be bound to the metal nanoparticle surface, that is, the metal nanoparticles are only bound to the polymerizable moieties. In this example, biological probe materials are immobilized to the hydrogel microdots via binding to backbone structure of the polymers that will make up the hydrogel, such as by binding the biological probe material to the polymer backbones of hydrogel precursors before the precursor polymers are cross-linked to form the hydrogel.

The biological material is known in the art as a probe, as it is the material that will selectively bind to other biological material matching or complementing its biological structure. As indicated above, various approaches are available to immobilize such biological materials to the hydrogel microdots, i.e., the probe material can be bound to the metal nanoparticle surface or in alternate embodiments to the backbone structure of the polymers that will make up the hydrogel, such as by binding the biological probe material to the polymer backbones of hydrogel precursors before the precursor polymers are cross-linked to form the hydrogel. The biomolecular material in various embodiments differs from dot to dot, such that each of the dots in an array of dots is used to indicate the presence or absence of a different biological material, such as to test for a variety of genes, proteins, or other biological materials in a sample under test.

In the example of FIG. 4, the metal nanoparticles with functionalities are suspended in a solvent, and the solvent solution is deposited into wells formed in a substrate material at 403. The substrate material in some embodiments is glass, such as quartz glass, but in other embodiments is any other suitable substrate material. Once the solution containing the solvent and the suspended metal nanoparticles bound to the biomolecular probe material is deposited in the wells, the solvent is allowed to evaporate at 404. Evaporation in one embodiment occurs on its own over time, while in other embodiments occurs with the help of elevated temperature, moving air across the surface, or by other means. The evaporated solvent leaves deposited metal nanoparticles in the well, to which hydrogel precursor polymers are added at 405. The precursor polymers are in this example deposited as a liquid, which suspends the functionalized metal nanoparticles. The precursor polymers in this example are photopolymerizable, and when exposed to light at 406 are photopolymerized or cross-linked, forming a hydrogel dot with a three-dimensional porous structure such that the metal nanoparticles are suspended within the hydrogel dot.

The hydrogel microdots in this example are characteristic of three-dimensional porous structures with more surface area accessible to sample biological materials under test. This comprises in various embodiments extending to a height above the substrate that is greater than a certain percentage of the diameter of the dot, such as rising at least 20%, 40%, 60%, 80%, or to 100% the diameter of the dot. For example, a dot in one embodiment rising at least 40% the diameter of the dot in which the dot is 100 micrometers in diameter would rise to a height of at least 40 micrometers above the surface of the substrate. This provides a greater surface area than a flat dot of the same diameter, enhancing the array designer's ability to pack more dots into a given area or increasing the surface area of a dot of a given diameter so that its hybridization or binding capability is enhanced.

A pictorial diagram illustrating fabrication of a biomolecular array using the example method of FIG. 4 is provided in FIG. 5. Here the beaker 501 shows a solution of a solvent, having functionalized metal nanoparticles suspended therein. The magnified view of a metal nanoparticle shows a number of biomolecules attached to the metal nanoparticle. Although a single beaker of particles is shown here, in many embodiments a different solution will be prepared for different dots or for each dot, such that each dot in an array includes metal nanoparticles bound to a different probe biomolecular material. The prepared solution may therefore be used to produce hundreds or thousands of arrays, due to the relatively small size of the dot formed using each solution. The solutions prepared at 501 are deposited into wells in the substrate as shown at 502, and the solvent is allowed to evaporate. Once the solvent has evaporated, the metal nanoparticles remain, bound to the various biomolecules used as probe material for each of the dots in the array.

A photopolymerizable hydrogel precursor solution is then deposited in each of the wells at 503, and the substrate with the metal nanoparticles suspended in the hydrogel precursors in each well is exposed to light to polymerize or cross-link the hydrogel precursors to form a hydrogel. The hydrogel of each dot therefore suspends the metal nanoparticles bound to the probe biomolecules, with each dot having different probe biomolecules bound to the metal nanoparticles. The dots form an array as shown at 504, such as a square array of dots that are approximately 100 micrometers in diameter, or any other array of dots of any appropriate diameter.

In use, the biological array as shown at 504 is exposed to a biological sample. The biological sample is first tagged or marked with a fluorescent material known to fluoresce or emit light. The fluorescent material in some examples is excited by light, and emits light having a known wavelength or frequency. This enables easy detection of the fluorescent material in the biological material sample.

The tagged material is exposed to the biological array, such as by preparing the biological material in solution such as water and placing a sample of the test solution on the array surface. The tagged biological material in the sample under test binds selectively to the various probe biomolecules in the various dots in the array, such as where a gene or DNA sequence binds to a matching or complementary DNA sequence bound to the metal nanoparticles in a specific dot. Once the array has been exposed to the tagged sample biological material, the dots having probe biomolecules that have bound to biological material in the tagged sample will fluoresce or glow.

The example metal nanoparticle hydrogel biological arrays described here illustrate how various features result in improved sensitivity and better detection, such as by improved fluorescence due to the metal enhanced fluorescence effect. They also illustrate how a hydrogel dot shape that is not substantially flat or planar results in a greater surface area for a given dot size, enabling the array designer to create a more dense array, create an array with greater dot surface area for better probe, or create an array with a combination of both benefits. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. (canceled)

2. (canceled)

3. (canceled)

4. (canceled)

5. (canceled)

6. (canceled)

7. (canceled)

8. (canceled)

9. (canceled)

10. (canceled)

11. A metal nanoparticle hydrogel biological array, comprising:
a substrate;
a plurality of hydrogel dots arranged in an array on the substrate, each of the plurality of hydrogel dots comprising biomolecular probe material and a plurality of metal nanoparticles.

12. The metal nanoparticle hydrogel biological array of claim 11, wherein the plurality of hydrogel dots are 100 micrometers or smaller in diameter.

13. The metal nanoparticle hydrogel biological array of claim 11, wherein the hydrogel comprises hydrogel polymerized on the substrate such that metal nanoparticles placed on the substrate are embedded in the hydrogel.

14. The metal nanoparticle hydrogel biological array of claim 11, wherein the biomolecular probe material in the plurality of hydrogel dots varies for each of the plurality hydrogel dots.

15. The metal nanoparticle hydrogel biological array of claim 11, further comprising a plurality of wells in the substrate, the plurality of hydrogel dots formed in the plurality of wells.

16. The metal nanoparticle hydrogel biological array of claim 11, wherein the biomolecular probe material is immobilized to hydrogel backbones.

17. The metal nanoparticle hydrogel biological array of claim 11, wherein the biomolecular probe material is immobilized to the metal nanoparticles.

18. The metal nanoparticle hydrogel biological array of claim 11, wherein the metal nanoparticles comprise at least one of silver and gold.

19. The metal nanoparticle hydrogel biological array of claim 11, wherein the hydrogel comprises hydrogel precursors photopolymerized on the substrate.

20. The metal nanoparticle hydrogel biological array of claim 11, wherein the hydrogel has a three-dimensional structure having an exposed surface that is not substantially planar.
